(19) United States
(12) Patent Application Publication
(10) Pub. No.: US 2010/0291794 A1
(43) Pub. Date: Nov. 18, 2010

(54) SATA TO IPASS CABLE CONNECTOR

(75) Inventors: Fu-Yong Luo, Dongguan City (CN); Jun-Tao Huang, Dongguan City (CN)

Correspondence Address: MOLEX INCORPORATED, 2222 WELLINGTON COURT, LISLE, IL, 60532, US

(73) Assignee: Molex Incorporated, Lisle, IL (US)

(21) Appl. No.: 12/759,792

(22) Filed: Apr. 14, 2010

(30) Foreign Application Priority Data
Apr. 14, 2009 (CN) 200920149058.7
Apr. 14, 2009 (TW) 98206395

(51) Int. Cl. H01R 11/00

(52) U.S. Cl. 439/502

(57) ABSTRACT

A cable connector comprises four cables, four SATA socket connectors connected with an end of the four cables respectively, and an IPASS™ connector connected with the other end of the four cables; wherein, the SATA socket connector comprises: an insulating body, the center of the insulating body protruding forwardly to form a L-shaped tongue plate, the periphery of the insulating body further protruding forwardly to form a frame which encloses the tongue plate; and a plurality of conductive terminals, each of the conductive terminals being provided with a butting end at the tongue plate side and a soldering end extending backwardly from the butting end, and the soldering end being electrically connected with one end of the cable. The spatial positions of these four SATA socket connectors of the cable connector can be changed flexibly for adapting to changes in the practical application environment, so as to obtain more flexible and convenient use of the cable connector.

### REFERENCE TO RELATED APPLICATIONS

The Present Application claims priority to prior-filed Chinese Patent Application No. 200920149058.7, entitled “Cable Connector,” and filed 14 Apr. 2009, the contents of which is fully incorporated in its entirety herein.

### BACKGROUND OF THE PRESENT APPLICATION

The Present Application relates generally to an electrical connector and, in particular, to a cable connector.

The conventional SATA (Serial Advanced Technology Attachment, a serial hardware driver interface based on the industry standards) socket connector is soldered onto a circuit board, and then connected to a cable having the SATA plug connector to provide a signal connection. An example of a conventional cable connector is disclosed in the Chinese Patent No. 200620003221.5, wherein the butting connector is a SATA socket connector which is soldered onto a circuit board, and the center of the insulating body of the SATA socket connector protrudes forwardly to form an L-shaped tongue plate. The periphery of the insulating body protrudes forwardly to form a frame which encloses the tongue plate. The SATA socket connector is connected with a cable connector having the SATA plug connector to provide a signal connection. This connection solution may be applied in situations in which, for example, a server requires a plurality of arranged SATA socket connectors, resulting in a compacted space. In such a case, since the SATA socket connector is fixed by soldering to the circuit board, it is impossible to change the spatial position to adapt to the surrounding application environment. Consequently, a user tends to suffer from the interference of peripheral components of the SATA socket connector during plugging or pulling the cable connector with a corresponding SATA plug connector, leading to inconvenience in use.

### SUMMARY OF THE PRESENT APPLICATION

An object of the Present Application is to provide a cable connector, in which the spatial positions of the SATA socket connector can be changed flexibly for adapting to changes in the practical application environment, so as to obtain a more flexible and convenient use of the cable connector. Another object of the Present Application is to provide a cable connector, in which the structure of the socket connector is stable.

To achieve the objects, the Present Application provides a cable connector, which comprises at least one cable, at least one first connector connected with an end of the at least one cable respectively, and a second connector connected with the other end of the at least one cable, the first connector comprises: an insulating body, the center of the insulating body protruding forwardly to form a L-shaped tongue plate, the periphery of the insulating body further protruding forwardly to form a frame which encloses the tongue plate; and a plurality of conductive terminals, each of the conductive terminals being provided with a butting end at the tongue plate side and a soldering end extending backwardly from the butting end, and the soldering end being electrically connected with one end of the cable.

The first connector further comprises a first casing which is over molded on the back side of the insulating body and two fixing pins arranged on the insulating body, the fixing pins are provided with barbs which are bent and extend to the back side of the insulating body, and the barbs are engaged with the first casing so as to tighten the first casing to prevent detachment. Additionally, the first connector further comprises a second casing which is over molded on the periphery of the first casing.

The first casing comprises two via holes running therethrough in the up-and-down direction, and the second casing is provided with fixing posts filled into the via holes of the first casing. Preferably, the second connector is an IPASS™ connector, and the first connector is a SATA socket connector.

Compared with the prior art, the Present Application has the following beneficial effects. First, a plurality of SATA socket connectors are connected with an IPASS™ connector via a cable, wherein the IPASS™ connector is plugged into a circuit board (IPASS™ is a trademark for a connector applied by the connector manufacturer, Molex Incorporated, and this IPASS™ connector is generally applied in the server storage market), so that the spatial positions of these SATA socket connectors can be changed flexibly for adapting to changes in the application environment. As a consequence, the user can conveniently plug a plurality of corresponding plug connectors. Additionally, the socket connector of the cable connector can use the barbs to tighten the first casing, and use the first casing to fix the cover plate and the second casing, resulting in the stability of the overall structure.

### BRIEF DESCRIPTION OF THE FIGURES

The organization and manner of the structure and operation of the Present Application, together with further objects and advantages thereof, may best be understood by reference to the following Detailed Description, taken in connection with the accompanying Figures, wherein like reference numerals identify like elements, and in which:

FIG. 1 is a perspective view of a cable connector according to the Present Application;

FIG. 2 is an exploded perspective view of a SATA socket connector in the cable connector of FIG. 1;

FIG. 3 is an exploded perspective view of the SATA socket connector of FIG. 2;

FIG. 4 is an exploded perspective view of the SATA socket connector of FIG. 2;

FIG. 5 is a perspective view of the SATA socket connector of FIG. 3, partially assembled;

FIG. 6 is a perspective view of the SATA socket connector of FIG. 3, partially assembled;

FIG. 7 is a perspective view of the SATA socket connector of FIG. 2, fully assembled; and

FIG. 8 is a front view showing the SATA socket connector of FIG. 7.

### DESCRIPTION OF THE PREFERRED EMBODIMENTS

While the Present Application may be susceptible to embodiment in different forms, there is shown in the Figures, and will be described herein in detail, specific embodiments, with the understanding that the disclosure is to be considered an exemplification of the principles of the Present Application, and is not intended to limit the Present Application to that as illustrated.

In the illustrated embodiments, directional representations—i.e., up, down, left, right, front, rear and the like, used for explaining the structure and movement of the various elements of the Present Application, are relative. These representations are appropriate when the elements are in the position shown in the Figures. If the description of the position of the elements changes, however, it is assumed that these representations are to be changed accordingly.

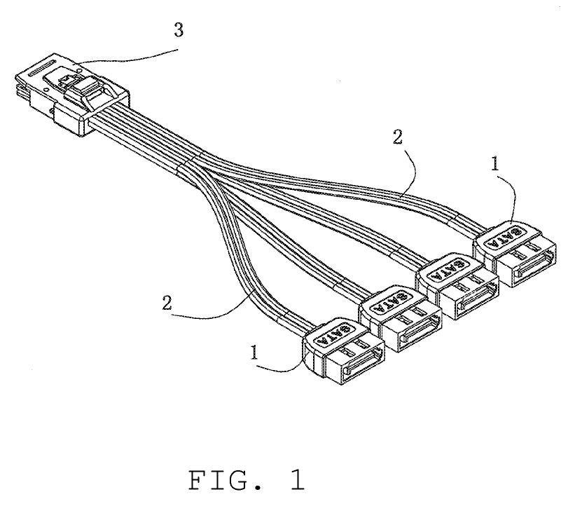

By taking a cable connector with a SATA connector and an IPASS™ connector as an example, reference will be made to the accompanying drawings to further describe the Present Application in detail. As shown in FIG. 1, the cable connector comprises four cables 2, four SATA connectors 1 connected with ends of the four cables 2 respectively, and an IPASS™ connector 3 connected with other ends of the four cables 2; wherein the IPASS™ connector 3 can be plugged to a circuit board (not shown).

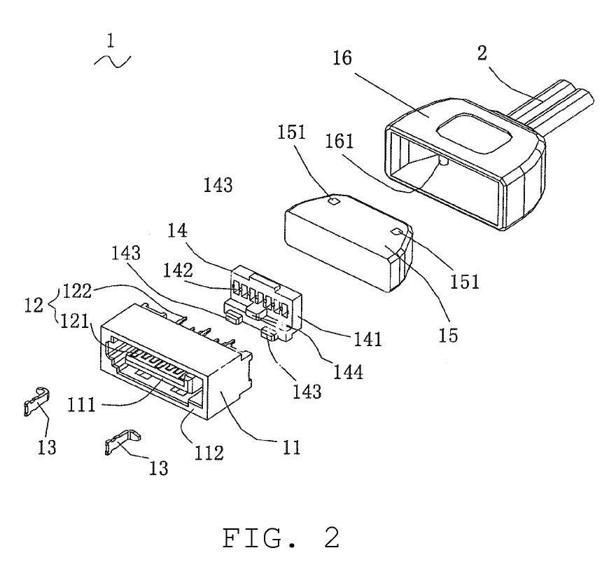

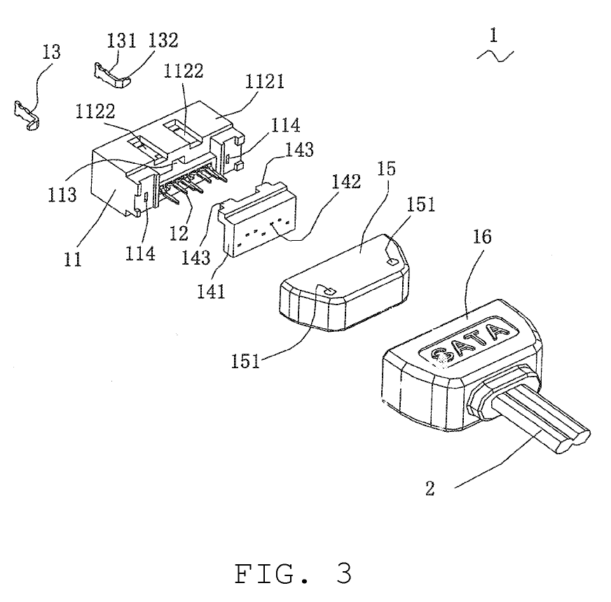

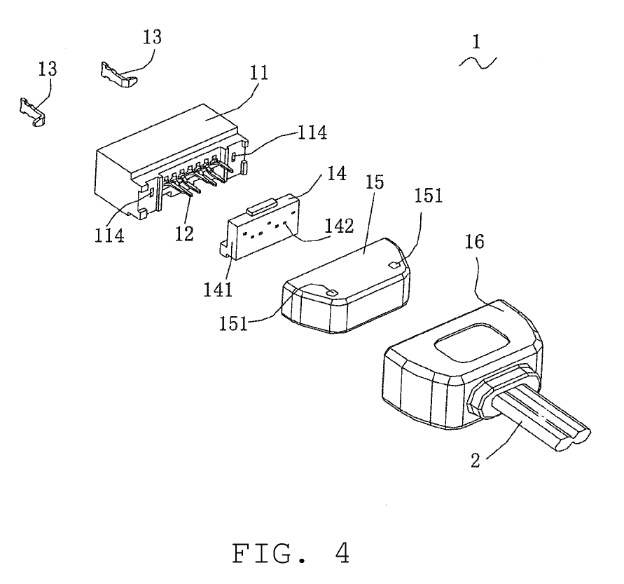

As shown in FIGS. 2-4, the SATA connector 1 is reconstructed from a SATA socket connector commonly arranged on a circuit board. The SATA connector 1 comprises an insulating body 11, a plurality of conductive terminals 12, two fixing pins 13 provided on the insulating body 11, a cover plate 14 fixed at the back end of the insulating body 11, a first casing 15 enveloping the back side of the insulating body 11 and the cover plate 14, and a second casing 16 enveloping the periphery of the first casing 15.

The insulating body 11 is made of an insulating material by an over molding process, with the center of the insulating body 11 protruding forwardly to form an L-shaped tongue plate 111. The periphery of the insulating body 11 protrudes forwardly to form a frame 112, which encloses the tongue plate 111 to form a butting space. The frame 112 is provided with two buckling grooves 1122 on the sidewall 1121 thereof, and the insulating body 11 is provided with a positioning hole 113 in the back wall thereof. The insulating body 11 is further provided at both sides with two through holes 114 running therethrough in fore-and-aft direction.

Each conductive terminal 12 is provided with a butting end 121 at the tongue plate 111 side and a soldering end 122 extending backwardly from the butting end 121. Each fixing pin 13 comprises a fixing portion 131 extending in the butting direction and a barb 132 bending perpendicularly and outwardly from the fixing portion 131, wherein the fixing pin 13 is a sheet which tapers from front to back prior to being bent to form the barb 132, so that the fixing portion 131 may pass through and be fixed into the through hole 114 of the insulating body 11 from the front, and the barb 132 extends out of the back side of the insulating body 11.

The cover plate 14 is made of an insulating material preferably by an over-molding process. The cover plate 14 comprises a base 141, and two first bumps 143 and a second bump 144 extending forwardly from the base 141. The base 141 is provided with several via holes 142 running therethrough in fore-and-aft direction, so that the soldering ends 122 of the plurality of conductive terminals 12 run backwardly through the via holes 142 respectively to extend out of the back side of the cover plate 14 and are further connected with one end of the cable 2. The cover plate 14 is arranged at the back end of the insulating body 11, with two first bumps 143 engaging with two buckling grooves 1122 of the insulating body 11 respectively, and the second bump 144 engaging with the positioning hole 113 of the insulating body 11, so that the cover plate 14 is fixed to the back end of the insulating body 11. As a result, the passage at the back end of the insulating body 11 is sealed to prevent the molten plastic from flowing into the butting space during molding the first casing 15, which otherwise will bring out inferior products.

The first casing 15 is preferably made of a polyethylene material by direct injection over-molding on the back end of the insulating body 11 which is provided with fixing pins 13 and the cover plate 14. The first casing 15 is coupled with the barbs 132 of two fixing pins 13. Namely, by means of barbs 132 of two fixing pins 13, it is possible to tighten the first casing 15 to prevent the first casing 15 from detaching from the insulating body 11. The first casing 15 is further provided with two via holes 151 running therethrough from top to bottom. Polyethylene has a low melting point and good temperature shrinkage, which helps to protect the soldering position between the cable 2 and the soldering portion 122 of the conductive terminal 12 and settle the problem of shrinkage during the injection molding of the second casing 16.

The second casing 16 is preferably made of polyvinyl chloride material by injection over-molding again on the periphery of the first casing 15, so that the second casing 16 is provided with two fixing posts 161 running therein to correspond to via holes 151 of the first casing 15, so as to enhance the engagement between the second casing 16 and the first casing 15. Polyvinyl chloride has good mechanical properties, and is suitable for being a housing due to its wear and corrosion resistance.

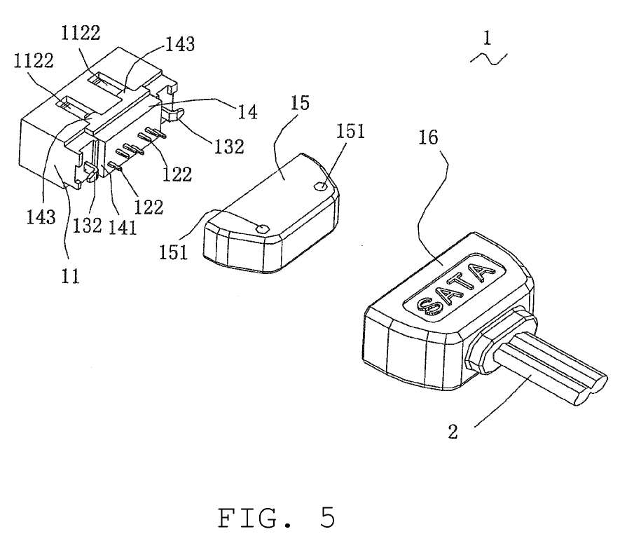

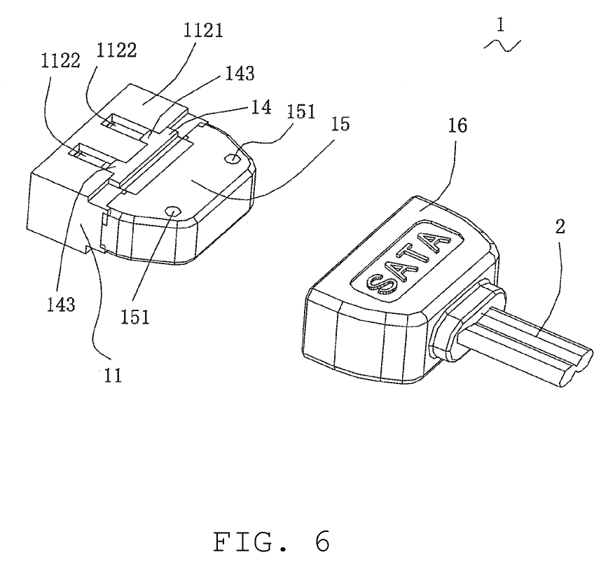

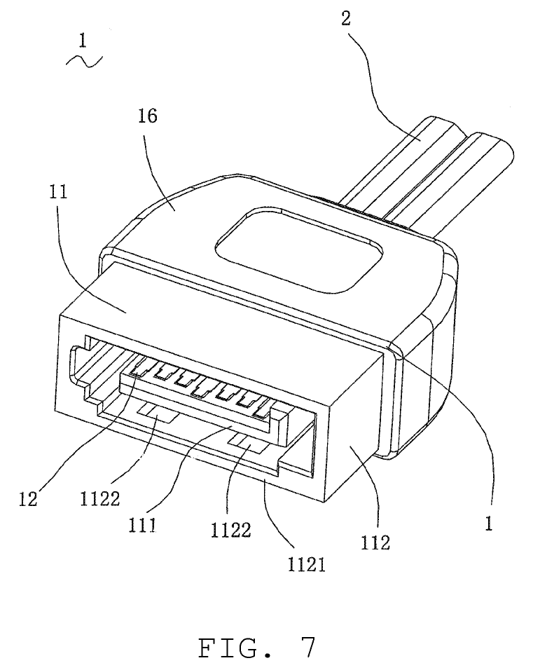

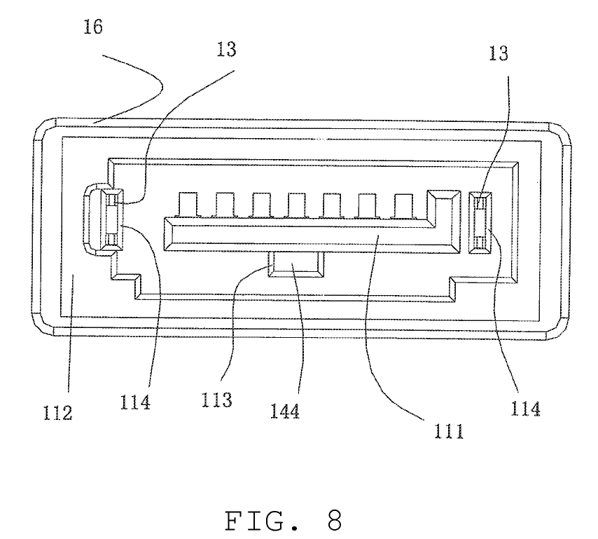

The manufacture and assembly process of the cable connector according the above preferred embodiments will now be described, with reference to FIGS. 2-8. First, a plurality of conductive terminals 12 are arranged on the tongue plate 111 of the insulating body 11, the two fixing pins 13 in a sheet shape are respectively inserted into the through holes 114 of the insulating body 11 from front to back (at this moment, the fixing pins 13 have not been bent to form the barbs 132), and then the ends of fixing pins 13 which are exposed at the back end of the insulating body 11 are bent perpendicularly and outwardly to form the barbs 132 of the fixing pins 13. Second, the two first bumps 143 and the second bump 144 on the cover plate 14 are aligned with the two buckling grooves 1122 and the positioning hole 113 of the insulating body 11 respectively, and the soldering ends 122 of the conductive terminal 12 are leaded to pass through the via holes 142 of the cover plate 14, so as to fix the cover plate 14 to the back side of the insulating body 11 from back to front. Third, one end of the cable 2 is soldered with the soldering end 122 of the conductive terminal 12. Fourth, the first casing 15 is made of PE material by injection over-molding on the back end of the insulating body 11 and the periphery of the cover plate 14, so that the barbs 132 are engaged with the first casing 15 to tighten the first casing 15 to prevent detachment thereof. Fifth, the second casing 16 is made by injection over-molding again on the periphery of the first casing 15, and the fixing posts 161 of the second casing 16 are filled into the via holes 151 of the first casing 15 to enhance the engagement between the second casing 16 and the first casing 15, thus a combination of a SATA connector 1 and a cable 2 is made. Finally, the other ends of four cables 2 are electrically connected with the IPASS™ connector 3, wherein, the four cables 2 are assembled with four SATA connectors 1 in the above process, thus the cable connector according to the Present Application is completed.

In the cable connector of the Present Application, four SATA socket connectors 1 are connected with the IPASS™ connector 3 via the cables 2, wherein the IPASS™ connector 3 is plugged into a circuit board, so that the spatial positions of these four SATA socket connectors 1 can be changed flexibly for adapting to changes in the application environment. As a consequence, the user can conveniently plug another four cable connectors comprising the corresponding SATA plug connector (not shown in the figure), without interference from the peripheral components on the circuit board. Besides, the SATA socket connector 1 of the cable connector uses the barbs 132 on the fixing pins 13 to tighten the first casing 15, and uses the first casing 15 to fix the cover plate 14 and the second casing 16, so that the overall structure is stable and is not prone to detach during pulling.

While a preferred embodiment of the Present Application is shown and described, it is envisioned that those skilled in the art may devise various modifications without departing from the spirit and scope of the foregoing Description and the appended Claims.

What is claimed is:

1. A cable connector, the cable connector comprising:
at least one cable;
at least one first connector, each first connector connected to an end of one cable; and
a second connector, the second connector connected with the other end of the at least one cable;
wherein the first connector comprises:
an insulating body, a center of the insulating body protruding forwardly to form a L-shaped tongue plate, a periphery of the insulating body further protruding forwardly to form a frame which encloses the tongue plate; and
a plurality of conductive terminals, each conductive terminal provided with a butting end at the tongue plate side and a soldering end extending backwardly from the butting end and being electrically connected with one end of the cable.

2. The cable connector of claim 1, wherein the first connector further comprises a cover plate fixed at a back end of the insulating body, the cover plate being provided with a plurality of via holes running therethrough in fore-and-aft direction, the soldering end of the conductive terminal running through the via holes and extending backwardly out of the cover plate.

3. The cable connector of claim 2, wherein the second connector is an IPASS™ connector which can be plugged to a circuit board, and the first connector is a SATA socket connector.

4. The cable connector of claim 2, wherein the first connector further comprises a first casing which is over-molded at a back side of the cover plate and the insulating body.

5. The cable connector of claim 4, wherein the second connector is an IPASS™ connector which can be plugged to a circuit board, and the first connector is a SATA socket connector.

6. The cable connector of claim 4, wherein the first connector further comprises two fixing pins arranged on the insulating body, the fixing pins are provided with barbs which are bent and extend to the back side of the insulating body, and the barbs are engaged with the first casing so as to tighten the first casing to prevent detachment.

7. The cable connector of claim 6, wherein the first connector further comprises a second casing which is over-molded on a periphery of the first casing.

8. The cable connector of claim 7, wherein the first casing is provided with a plurality of via holes running therethrough, and the second casing is over-molded on the periphery of the first casing, and is provided with a plurality of fixing posts running therein to correspond to the via holes of the first casing.

9. The cable connector of claim 2, wherein the first connector is provided with positioning holes at the back end of the insulating body, the frame is provided with buckling grooves at a sidewall thereof, and the cover plate protruding forwardly to form a plurality of positioning bumps to engage with the buckling grooves and positioning holes of the insulating body.

10. The cable connector of claim 9, wherein the second connector is an IPASS™ connector which can be plugged to a circuit board, and the first connector is a SATA socket connector.

11. The cable connector of claim 9, wherein the first connector further comprises a first casing which is over-molded at a back side of the cover plate and the insulating body.

12. The cable connector of claim 11, wherein the second connector is an IPASS™ connector which can be plugged to a circuit board, and the first connector is a SATA socket connector.

13. The cable connector of claim 11, wherein the first connector further comprises two fixing pins arranged on the insulating body, the fixing pins are provided with barbs which are bent and extend to the back side of the insulating body, and the barbs are engaged with the first casing so as to tighten the first casing to prevent detachment.

14. The cable connector of claim 13, wherein the first connector further comprises a second casing which is over-molded on a periphery of the first casing.

15. The cable connector of claim 14, wherein the first casing is provided with a plurality of via holes running therethrough, and the second casing is over-molded on the periphery of the first casing, and is provided with a plurality of fixing posts running therein to correspond to the via holes of the first casing.

16. The cable connector of claim 1, wherein the first connector further comprises a first casing which is over-molded at a back side of the insulating body.

17. The cable connector of claim 16, wherein the second connector is an IPASS™ connector which can be plugged to a circuit board, and the first connector is a SATA socket connector.

18. The cable connector of claim 16, wherein the first connector further comprises two fixing pins arranged on the insulating body, the fixing pins are provided with barbs which are bent and extend to the back side of the insulating body, and the barbs are engaged with the first casing so as to tighten the first casing to prevent detachment.

19. The cable connector of claim 18, wherein the first connector further comprises a second casing which is over-molded on a periphery of the first casing.

20. The cable connector of claim 19, wherein the first casing is provided with a plurality of via holes running therethrough, and the second casing is over-molded on the periphery of the first casing, and is provided with a plurality of fixing posts running therein to correspond to the via holes of the first casing.
